(19) United States
(12) Patent Application Publication
(10) Pub. No.: US 2011/0090257 A1
(43) Pub. Date: Apr. 21, 2011

(54) Touch Display Device, Touch Display System, and Method for Adjusting Touch Area Thereof

(76) Inventors: Chueh-Pin Ko, Hsichih (TW); Yu-Li Chen, Hsichih (TW)

(21) Appl. No.: 12/834,058

(22) Filed: Jul. 12, 2010

(30) Foreign Application Priority Data
Oct. 20, 2009 (TW) 098135447

(51) Int. Cl. G09G 5/00; G06F 3/041

(52) U.S. Cl. 345/660; 345/173

(57) ABSTRACT

A touch display device, a touch display system, and a method for adjusting a touch area thereof are disclosed. The touch display system comprises a computer system and the touch display device. The touch display device provides a touch area with a touch control function. The method comprises following steps: receiving an image signal and displaying an image representing the image signal on the touch display device; detecting and obtaining a signal resolution of the image signal; detecting and obtaining a display status displayed by the touch display device, wherein the signal resolution and the display status are used to determine the boundary of the image; determining whether the touch display device simultaneously displays the image and an inactive area, wherein the inactive area is the region where the touch display device does not display the image; and if yes, adjusting the coordinates of the touch area such that the touch area and the image correspond with each other.

### BACKGROUND OF THE INVENTION

1. Field of the Invention

The present invention relates to a touch display device, a touch display system and a method for adjusting a touch area thereof, and more specifically, to a touch display device with adjustable touch area, a touch display system and a method for adjusting a touch area,

2. Description of the Related Art

With technology advancement, touch screen system applications are increasing. As an example, Windows®7, the new operating system launched by Microsoft®, has included the function to support a touch display system.

In the prior art, the touch display system usually displays the image of the image signal which is outputted from a computer system onto the touch display device, then feeds back the coordinates of the touch point of the touch area to the computer system for further processing. Another type of touch display device is disclosed by the prior art, wherein the touch control module composes a transparent touch panel mounted in front of an ordinary displaying device, and the coordinates on the touch panel can be obtained by the touch control module. The coordinate signal is then sent back to the computer system for controlling the computer system.

Generally, the image displayed by the touch display devices should correspond to the touch area. However, specifications, size and settings of signal resolution vary in different displaying devices, therefore displaying devices usually consist of settings for adjusting the displaying status into different modes such as Aspect, Full or 1:1 ratio. The Aspect view allows the image to fit from the top to the bottom of the screen; the 1:1 view adopts a pixel mapping technique which displays the image in the center of the displaying device, therefore, areas to the top and the bottom, or left and right of the image on the displaying device might generate an inactive area, wherein the inactive area is the region on the displaying device where no image is displayed, and it is known as the Black Area.

Refer to FIG. 1 together with the following section which describes a screen of a touch display device in the prior art. As shown in FIG. 1, assume that the displaying status is set as 1:1 with image resolution 1280*800. Under this condition, screen 90 will display an image 92 with an inactive area 93.

However, the touch control module cannot identify the size of image 92, so the size of screen 90 is used as the boundary of a touch area 91. If a user wishes to press point A on image 92, essentially, the user needs to press point A′ in order to correspond to point A. This has caused user inconvenience.

In order to resolve the abovementioned problem, it is necessary to develop a new touch display system with a method for touch area adjustment.

### SUMMARY OF THE INVENTION

The present invention provides a touch display device which allows for touch area adjustment.

Another object of the present invention is to provide a touch display system, which allows touch area adjustment.

Yet another object of the present invention is to provide a method of touch area adjustment.

To achieve the above mentioned objectives, the touch display device of the present invention is able to receive an image signal and display an image of the image signal. The touch display device comprises a touch control module and a displaying device. The touch control module provides a touch area with a control function. The displaying device is used to display an image. The displaying device comprises a display status adjustment module to control the display status of the displaying device. The signal resolution and the display status are used to determine the boundary of the image. The touch control module uses the display status adjustment module to obtain both the signal resolution of the image signal and the display status, and determine whether an image and an inactive area are simultaneously displayed by the displaying device, wherein the inactive area is the region on the displaying device where no image is shown; and if yes, the touch control module adjusts the coordinates of the touch area such that the boundary of the touch area and the image correspond with each other.

The touch display system comprises a computer system and a touch display device. The computer system comprises an operating system to output an image signal. The touch display device is electrically connected with the computer system in order to receive and display an image representing the image signal. The touch display device comprises a touch control module and a displaying device. The touch control module provides a touch area with a control function. The displaying device is used to display the image. The displaying device comprises a display status adjustment module to control the display status of the displaying device. The signal resolution of the image signal and the display status are used to determine the boundary of the image. The operating system is used to obtain both the signal resolution of the image signal and the display status, and to determine whether both the image and an inactive area are simultaneously displayed on the displaying device; wherein the inactive area is the region on the displaying device where no image is shown; and if yes, the touch control module or the operating system adjusts the coordinates of the touch area such that the boundary of the touch area and the image correspond with each other.

The method of adjusting the touch area comprises the following steps: receiving an image signal and displaying an image representing the image signal on the touch display device; detecting and obtaining a signal resolution of the image signal; detecting and obtaining a signal resolution of the image signal; detecting and obtaining a display status of the touch display device, wherein the signal resolution and the display status are used to determine the boundary of the image; determining whether the touch display device simultaneously shows the image and an inactive area, wherein the inactive area is the region on the displaying device where the image is not shown; and if yes, adjusting the coordinates of the touch area such that the boundaries of the touch area and the image correspond with each other.

### BRIEF DESCRIPTION OF THE DRAWINGS

FIG. 1 shows the screen of a touch display device in the prior art.

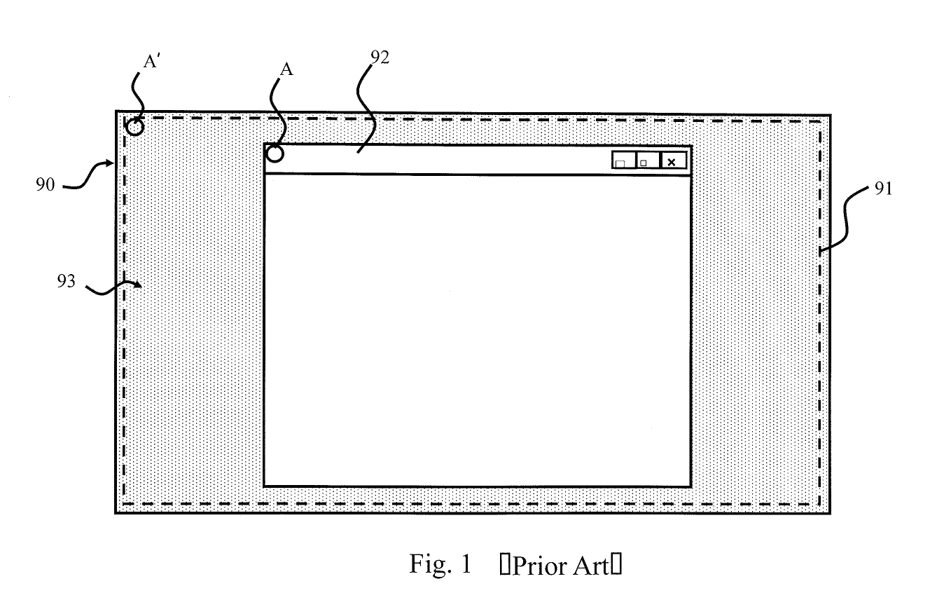

FIG. 2 shows the structure of a touch display system of the present invention.

FIG. 3 shows the screen of a touch display device of the present invention.

FIG. 4 shows a flow chart showing the touch area adjustment method of the first embodiment.

FIG. 4A shows the touch display device after the touch area has been adjusted.

FIG. 5 is a flow chart showing the touch area adjustment method of the second embodiment.

FIG. 6 is a flow chart showing the touch area adjustment method of the third embodiment.

FIG. 7 shows a new operating screen of the touch display device.

### DETAILED DESCRIPTION OF THE PREFERRED EMBODIMENT

The advantages and innovative features of the invention will become more apparent from the following preferred embodiments.

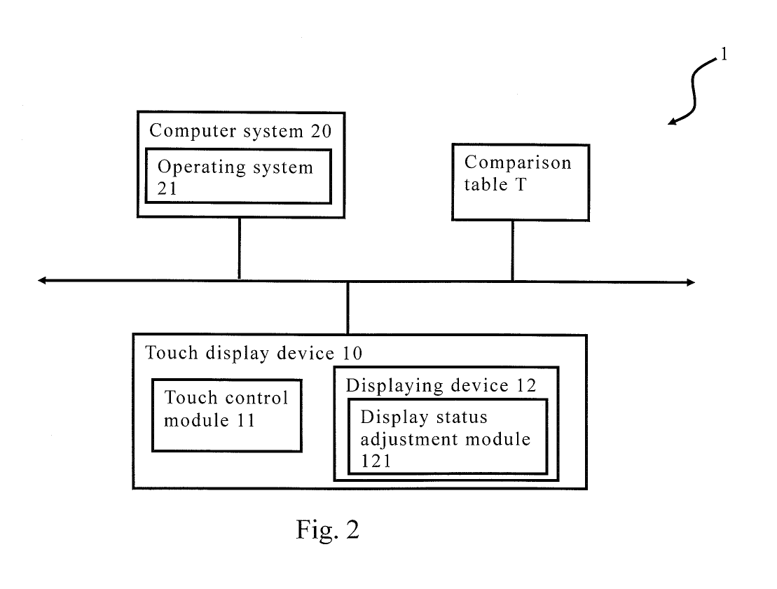

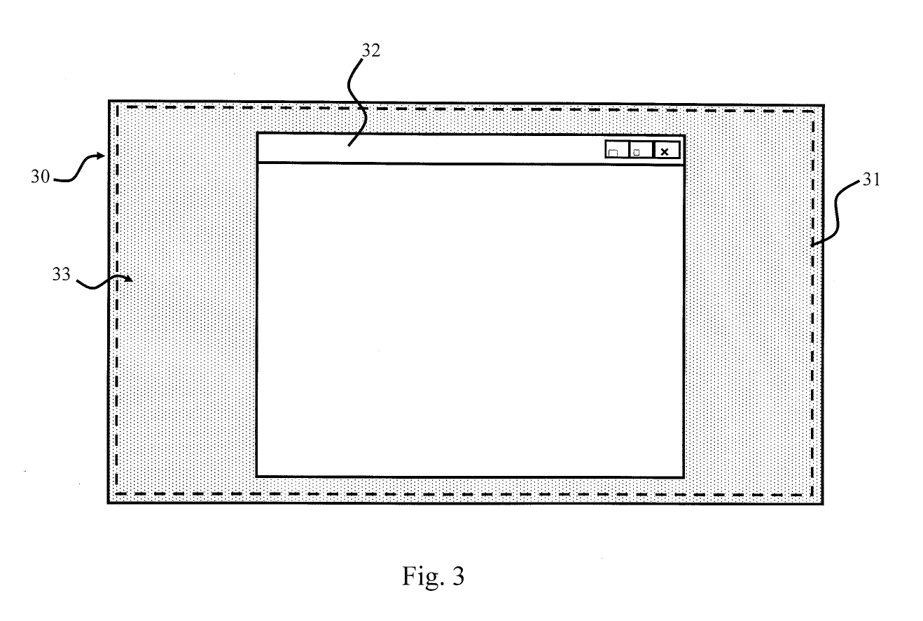

Refer to FIG. 2 and FIG. 3 in accordance with the touch display system and the screen of the present invention. FIG. 2 shows the structure of the touch display system. FIG. 3 shows the screen of the touch display device.

In the present invention, a touch display system 1 comprises a touch display device 10, a computer system 20 and a comparison table T. The touch display device 10 is electrically connected with computer system 20 for receiving an image signal. The touch display device 10 comprises a touch control module 11 and a displaying device 12. The touch control module 11 provides a touch area 31 with control functions, such that the user is able to control the computer system 20 by pressing the regions within in the touch area 31. The displaying device 12 is used to display an image; it can display an image 32 to represent the image signal on a screen 30. The displaying device 12 comprises a display status adjustment module 121 to control the display status of the displaying device 12, for example, the display status can be adjusted to Aspect, Full or 1:1 ratio. By controlling the settings of the display status, image 32 can be displayed in the center of the displaying device 12 which allows the image to fit from the top to the bottom of the screen, or the image can be presented by a pixel mapping technique. In one embodiment, the display status adjustment module 121 can be an electronic circuit, a software, a hardware, a firmware, or a combination of these components, however, the present invention is not only limited to these components.

The computer system 20 comprises an operating system 21 which is able to support the function of touch control, and can be used to output the image signal onto the displaying device 12 to show representing the image 32 of the image signal. Each image signal has a respective image resolution. The boundary of image 32 can be varied by using different combinations of image resolution and display status, which can be displayed on the screen 30.

Refer to FIG. 3 which shows an example of screen 30. In this example, it is assumed that display status adjustment module 121 sets the display status of displaying device 12 as 1:1 ratio, and the image resolution of the received image signal is 1280*800. As shown in FIG. 3, the image 32 and an inactive area 33 are shown on the screen 30 simultaneously, wherein the inactive area 33 is the region of the displaying device 12 where the image 32 is not shown. Meanwhile, the touch display system 1 performs the adjustment by either using the operating system 21 or the touch control module 11, such that the boundary of the touch area 31 and the image 32 correspond with each other. The method of adjustment will be described in a later section.

The touch display system 1 can also comprise a comparison table T. The comparison table T is used to store the corresponding values of the image resolution and the display status. With the information stored in the comparison table T, the touch display system 1 is then able to figure out the coordinates for adjusting the touch area 31. The comparison table T can be implemented in different modules to satisfy various embodiments, thus the present invention is not limited to the above description. The method of comparison will be discussed in a later section.

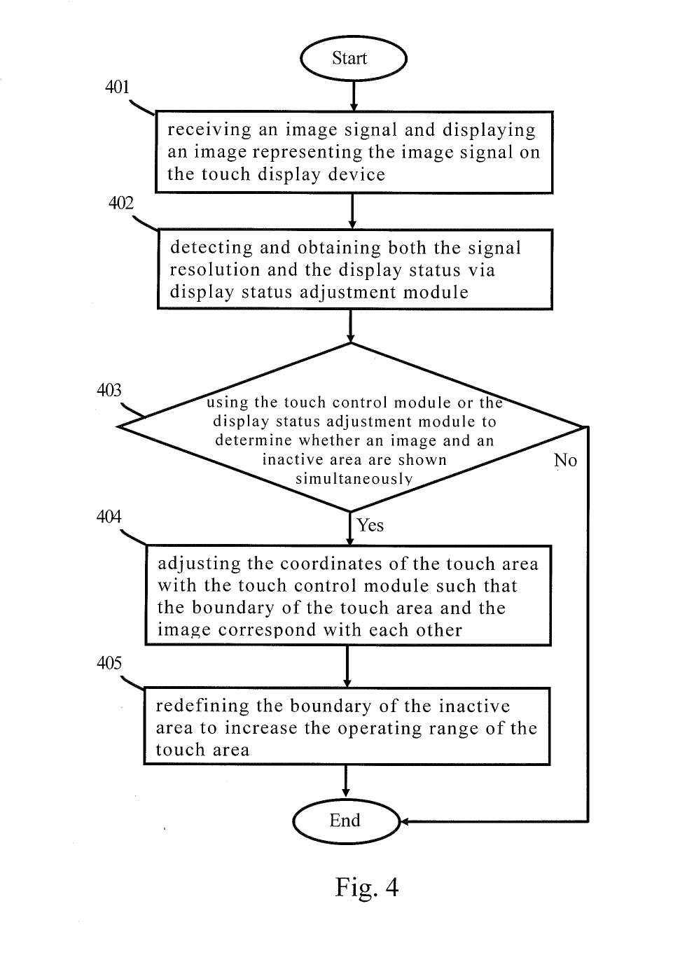

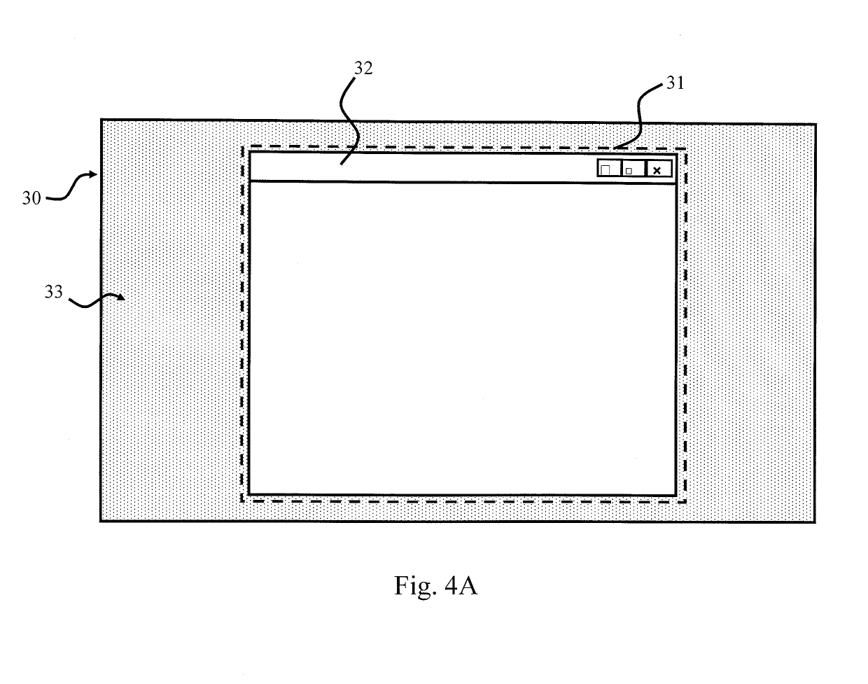

Next, refer to FIG. 4 to FIG. 6 for the flow charts of the touch area adjusting method in accordance with the present invention. Take note that although the touch area adjusting method is used by the touch display system 1 with the touch display device 10, it is not limited to be used exclusively by the touch display system 1.

Refer to FIG. 4 for a flow chart showing the touch area adjustment method of the first embodiment

First, proceed with step 401: receiving an image signal and displaying an image representing the image signal on the touch display device.

The computer system 20 transfers an image signal to the touch control device 10. After the touch control device 10 receives the image signal, a representing image 32 of the image signal can be shown on the displaying device 12.

Then proceed to step 402: detecting and obtaining both the signal resolution and the display status via display status adjustment module.

In step 402, the display status adjustment module 121 detects and obtains the signal resolution of the image signal from the computer system 20, and determines the settings of the display status adjustment module 121 from the display status of the touch display device 10.

Next proceed with step 403: using the touch control module or the display status adjustment module to determine whether an image and an inactive area are shown simultaneously.

In step 403, the process of determination is conducted by either the touch control module 11 or the display status adjustment module 121.

The following describes the decision process carried out by the touch control module 11. In the embodiment, the comparison table T is implemented in the touch control module 11. The signal resolution and the display status are determined from step 402, and then the display status adjustment module 121 transfers the result to the touch control module 11. By searching through the corresponding result in the comparison table T, the touch control module 11 can determine what is currently shown on the screen 30. Therefore the touch control module 11 is able to determine whether the image 32 and the inactive area 33 are shown simultaneously on the displaying device 12.

On the other hand, the display status adjustment module 121 can obtain the signal resolution and the display status, and then search through the corresponding result in the comparison table T. In this embodiment, the comparison table T is implemented in the display status adjustment module 121. Next, the display status adjustment module 121 determines whether the image 32 and the inactive area 33 are shown simultaneously on the displaying device 12, and then generates a corresponding signal according to the result obtained. Lastly, the corresponding signal is sent to the touch control module 11 for post-processing. Therefore, with the corresponding signal, the touch control module 11 is able to determine whether the image 32 and the inactive area 33 are shown simultaneously on the displaying device 12.

Take note that the touch control module 11 or the display status adjustment module 121 can also directly calculate whether inactive area 33 will be displayed according to the signal resolution and the display status.

The data of the touch control module 11 and the display status adjustment module 121 is transferred through Inter-Integrated Circuit (I2C), but the transferring medium of the present invention is not limited to this circuit.

If the screen 30 only shows the image 32, it indicates that the touch area 31 is corresponded with the image 32, therefore the determination process is terminated.

If both the image 32 and the inactive area 33 are shown simultaneously on the screen 30, it indicates that the boundary of the touch area 31 does not correspond with the image 32, therefore proceed with step 404: adjusting the coordinates of the touch area with the touch control module such that the boundary of the touch area and the image correspond with each other.

Refer to FIG. 4A and step 404 simultaneously in accordance with the present invention, which shows the touch display device after the touch area has been adjusted.

After obtaining signal resolution and the display status, the touch control module 11 is able to acquire the boundary of the image 32 by the comparison table T or the direct calculation of signal resolution and the display status. Therefore, as shown in FIG. 4A, the touch control module 11 in step 404 redefines the starting and the ending coordinates of the control area 31, such that the starting and the ending coordinates correspond with the boundary of the image 32.

Therefore users can operate touch display device 10 more accurately.

Take note that present invention can further proceed to step 405: redefining the boundary of the inactive area to increase the operating range of the touch area.

After readjusting the coordinates of the touch area 31 in step 404, the touch control module 11 can redefine the boundary of the inactive area 33 to increase the operating range of the touch area 31, thus enabling the touch area 31 to be more corresponding with the boundary of the image 32. More specifically, the touch control module 11 is able to increase the boundary of the touch area 31 by setting the boundary of the touch area 31 slightly larger than the boundary of the image 32, and it will slightly overlay the inactive area 33. As a result, users will find the operating process more convenient when it comes to pressing the corners of the touch area 31, such as the “close window” option.

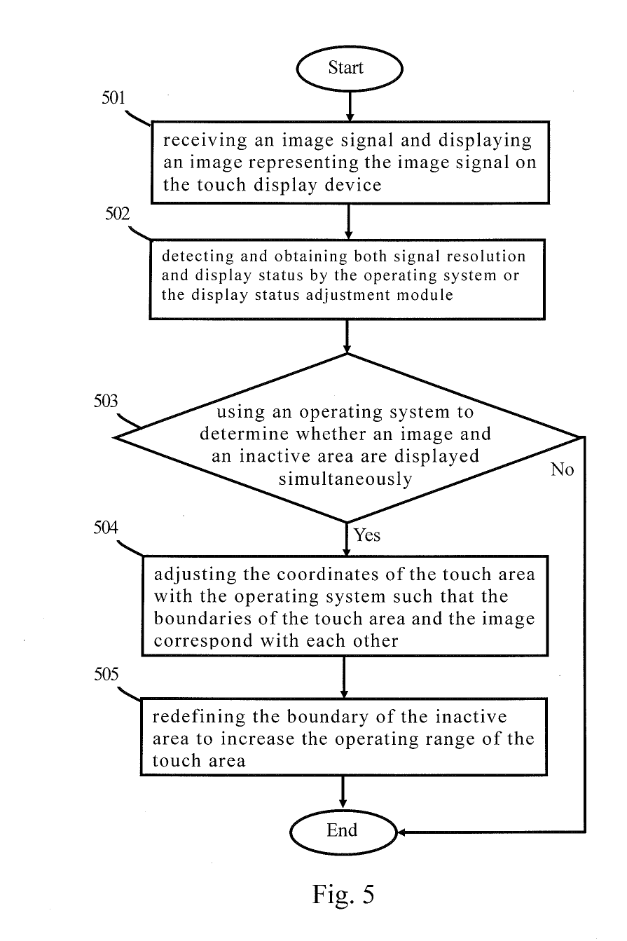

The touch area adjustment method can also be achieved by the second embodiment described in the subsequent section. Refer to FIG. 5 for a flow chart showing the touch area adjustment method of the second embodiment.

The touch area adjustment method of the second embodiment begins with step 501: receiving an image signal and displaying an image representing the image signal on the touch display device.

As in step 401, the computer system 20 transfers the image signal to the touch control device 10. After the touch control device 10 receives the image signal, the representing image 32 of the image signal can be shown on displaying device 12.

Then proceed to step 502: detecting and obtaining both signal resolution and display status by the operating system or the display status adjustment module.

In step 502, operating system 21 detects and obtains the signal resolution of the image signal from the computer system 20, and determines the display status of the touch display device 10 via the display status adjustment module 121. On the other hand, the operating system 21 can also make use of the display status adjustment module 121 to detect the display status and to return the signal resolution, but the present invention is not only limited to this arrangement.

The data between the computer system 20 and the display status adjustment module 121 can be transferred through Display Data Channel/Command Interface (DDC/CI), but the present invention is not limited to this interface.

Next proceed with step 503: using an operating system to determine whether an image and an inactive area are displayed simultaneously.

In this embodiment, the comparison table T is inbuilt into the operating system 21. After the signal resolution and the display status are obtained, the operating system 21 will make use of the comparison table T to determine whether the image 32 and the inactive area 33 will be shown simultaneously on the screen 30. On the other hand, with the displaying status and the signal resolution, the operating system 21 can also directly calculate whether the inactive area 33 will be displayed.

If the inactive area 33 is not shown on the screen 30, then terminate the adjustment process.

If the inactive area 33 is shown on the screen 30, then proceed with step 504: adjusting the coordinates of the touch area with the operating system such that the boundaries of the touch area and the image correspond with each other.

The operating system 21 is able to acquire the boundary of the inactive area 33 by the comparison table T or through direct calculation of the signal resolution and the display status. Therefore in step 504, the computer system 20 redefines the setting of the operating system 21, and directly filters out the touch control signal from the inactive area 33 to redefine the coordinates of the control area 31. In other words, after the computer system 20 receives a touch control signal from the touch control module 11, the touch control signal will be changed directly onto the corresponding position on the image 32, and that the image and the touch control signal from inactive area 33 are ignored. Therefore, as shown in FIG. 4A, the operating system 21 can redefine the coordinates of the touch area 31 by internal settings, which allows the boundary of the touch area 31 and the image 32 to correspond with each other.

Similarly, the second embodiment can proceed with step 505: redefining the boundary of the inactive area to increase the operating range of the touch area.

The operating system 21 is able to increase the boundary of the touch area 31 by setting the receptive area slightly larger than the boundary of the image 32, so that the boundary of the touch area 31 matches more closely with the image 32, allowing users to operate the device more conveniently.

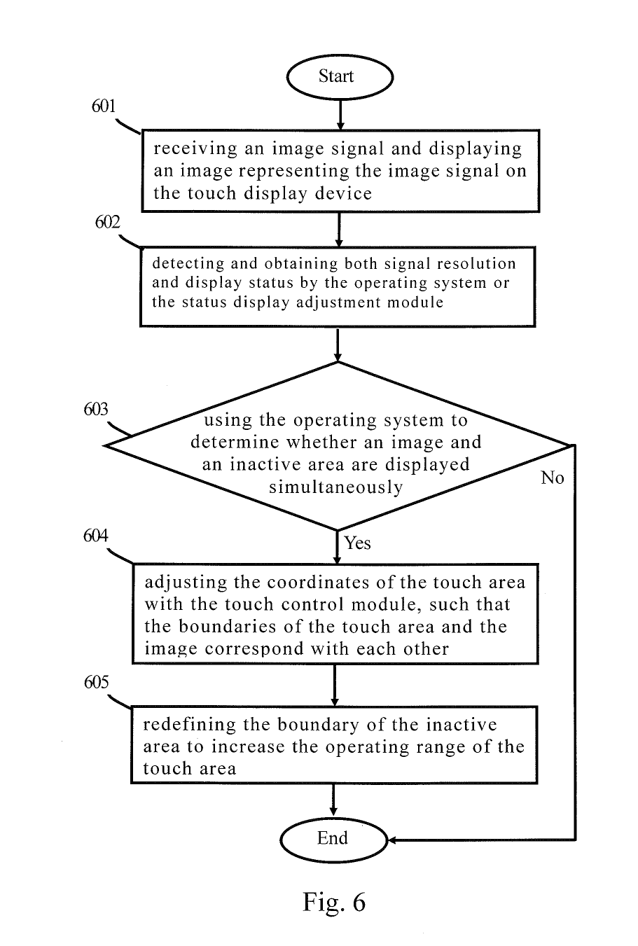

Next refer to FIG. 6 for a flow chart showing the touch area adjustment method of the third embodiment.

The process begins with step 601: receiving an image signal and displaying an image representing the image signal on the touch display device.

Step 601 is the same as step 501. In step 601, the computer system 20 transfers an image signal to the touch control device 10. After the touch control device 10 receives the image signal, the image 32 can be shown on the displaying device 12.

Then proceed to step 602: detecting and obtaining both signal resolution and display status by the operating system or the status display adjustment module.

The operating system 21 detects and obtains the signal resolution transferred from the computer system 20, or it can make use of the display status adjustment module 121 to determine the signal resolution and the display status. Step 602 and step 502 are the same.

Next proceed with step 603: using the operating system to determine whether an image and an inactive area are displayed simultaneously.

By the comparison table T or direct calculation of the displaying status and signal resolution, the operating system 21 can determine whether the image 32 and the inactive area 33 will be simultaneously displayed on the screen 30. Step 603 and step 503 are the same.

If the inactive area 33 is not displayed on the screen 30, then terminate the adjustment process.

If the screen 30 shows the inactive area 33, then proceed with step 604: adjusting the coordinates of the touch area with the touch control module, such that the boundaries of the touch area and the image correspond with each other.

Therefore after the determination process as shown in FIG. 4A, the operating system 21 will transmit the corresponding signal to the touch control module 11 in order to redefine the starting and the ending coordinates of the touch area 31 for matching with the boundary of the image 32. As a result, the boundaries of the touch area 31 and the image 32 correspond with each other.

The abovementioned corresponding signal can be transferred with a USB, but the present invention is not limited to this interface.

Similarly, the third embodiment can proceed with step 605: redefining the boundary of the inactive area to increase the operating range of the touch area.

In step 605, the touch control the module 11 is able to increase the boundary of the touch area 31 by setting the receptive area slightly larger than the boundary of the image 32, so that the boundary of the touch area 31 matches more closely with the image 32 and makes the operation more convenient.

Take note that the steps in the touch area adjustment method are not limited to the abovementioned sequence. The sequence of the steps can be altered as long as it can achieve the objective of the present invention.

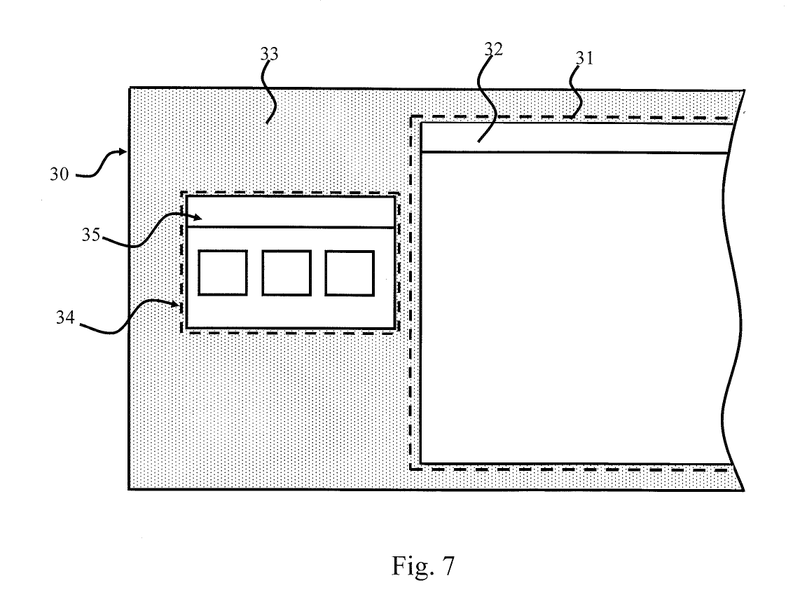

Furthermore, the present invention includes another embodiment. Refer to FIG. 7 for a new operating screen of the touch display device.

In the first and the third embodiment abovementioned, the coordinates of the touch area 31 are redefined by the touch control module 11, therefore the touch control module 11 is able to define the coordinates of a new operating area 34 in the boundary of inactive area 33. The new operating area 34 can provide options to control the computer system 20, such as short-cuts for sending and receiving emails. Furthermore, the new operating area 34 can also provide basic functions to control the displaying device 12 such as brightness or contrast adjustment, but the present invention is not limited to these functions. At the same time, the displaying device 12 can have a new operating image 35 in the boundary of the inactive area 33, such that the new operating area 34 and the new operating image 35 correspond with each other. The new operating image 35 can be displayed through the On-Screen Display (OSD) technology of the displaying device 12, but the present invention is not limited to this method. The coordinates of the new operating area 34 are redefined by the touch control module 11, therefore the touch control module 11 will transmit a controlling command to the computer system 20 or the displaying device 12 when the user presses on the new operating image 35. This allows the user to control the computer system 20 or to control the displaying device 12 more conveniently.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A touch display device which is able to receive an image signal and display an image representing the image signal, wherein the touch display device comprises:
a touch control module, wherein the touch control module provides a touch area with control functions; and
a displaying device which is used to display an image, wherein the displaying device comprises a display status adjustment module to control the display status of the displaying device, wherein a signal resolution of the image signal and the display status are used to determine the boundary of the image; wherein the display status adjustment module is used to determine the signal resolution of the image signal and the display status via the touch control module, and to determine whether the displaying device simultaneously displays the image and an inactive area, wherein the inactive area is the region on the displaying device where the image is not shown; and if yes, the touch control module adjusts the coordinates of the touch area such that the touch area and the image correspond with each other.

2. The touch display device as claimed in claim 1, wherein the display status adjustment module uses a comparison table to find a corresponding signal of the signal resolution and the display status, or the corresponding signal can be directly calculated with the signal resolution and the display status; the corresponding signal is then transferred to the touch control module to determine whether the image and the inactive area are displayed simultaneously on the displaying device.

3. The touch display device as claimed in claim 1, wherein the touch control module uses a comparison table to correspond with the signal resolution and the display status, or performs a direct calculation with the signal resolution and the display status to determine whether the image and the inactive area are displayed simultaneously on the screen.

4. The touch display device as claimed in claim 1, wherein the touch control module redefines the boundary of the inactive area to increase the operating range of the touch area, thus enabling the touch area to correspond with the boundary of the image.

5. The touch display device as claimed in claim 1, wherein the touch control module redefines the boundary of the inactive area to increase a new operating area, and displays a new operating image on the displaying device, such that the boundaries of the new operating area and the new operating image correspond with each other.

6. A touch display system comprising:
a computer system comprising an operating system used for transferring an image signal; and
a touch display device which is electrically connected with the computer system for receiving the image signal, and to display an image representing the image signal; wherein the touch display device comprises:
a touch control module, wherein the touch control module provides a touch area with control functions; and
a displaying device which is used to display the image, wherein the displaying device comprises a display status adjustment module to control the display status of the displaying device, wherein a signal resolution of the image signal and the display status are used to determine the boundary of the image; wherein the operating system is used to obtain the signal resolution of the image signal and the display status, and then determines whether the image and an inactive area are simultaneously shown on displaying device, wherein the inactive area is the region on the displaying device where the image is not shown; and if yes, the touch control module or the operating system adjusts the coordinates of the touch area such that the boundaries of the touch area and the image correspond with each other.

7. The touch display system as claimed in claim 6, the operating system obtains the display status via the display status adjustment module.

8. The touch display system as claimed in claim 6, the operating system obtains the signal resolution and the display status via the display status adjustment module.

9. The touch display system as claimed in claim 6, wherein the operating system uses a comparison table to correspond with the signal resolution and the display status, or performs a direct calculation with the signal resolution and the display status to determine whether the image and the inactive area are displayed simultaneously on the displaying device.

10. The touch display system as claimed in claim 6, wherein the touch control module or the operating system redefines the boundary of the inactive area to increase the operating range of the touch area, thus enabling the touch area to correspond with the boundary of the image.

11. The touch display system as claimed in claim 6, wherein the touch control module redefines the boundary of the inactive area to increase a new operating area, and display a new operating image on the displaying device, and that the boundary of the new operating area and the new operating image correspond with each other.

12. A touch area adjustment method for a touch display device, wherein the touch display device comprises a touch area with control functions, the method comprises the following steps:
receiving an image signal and displaying an image representing the image signal on the touch display device;
detecting and obtaining a signal resolution of the image signal;
detecting and obtaining a display status displayed by the touch display device, wherein the signal resolution and the display status are used to determine the boundary of the image;
determining whether the touch display device simultaneously displays the image and an inactive area, wherein the inactive area is the region on the touch display device where the image is not shown; and
if yes, adjusting the coordinates of the touch area such that the touch area and the image correspond with each other.

13. The touch area adjustment method as claimed in claim 12, further comprises the following steps:
using an operating system to detect and obtain the signal resolution of the image signal; and
using a display status adjustment module to detect and obtain the display status.

14. The touch area adjustment method as claimed in claim 12, further comprises the following step:
using a display status adjustment module to detect and obtain the signal resolution of the image signal and the display status.

15. The touch area, adjustment method as claimed in claim 12, wherein the steps of adjusting the touch area further comprises the following step:
using an operating system to adjust the coordinates of the touch area such that the boundaries of the touch area and the image correspond with each other.

16. The touch area adjustment method as claimed in claim 15, further comprises the following steps:
redefining the boundary of the inactive area to increase the operating range of the touch area, thus enabling the touch area to correspond with the boundary of the image.

17. The touch area adjustment method as claimed in claim 12, wherein the steps of adjusting the touch area further comprises the following step:
using a touch control module to redefine the coordinates of the touch area, such that the boundary of the touch area and the image correspond with each other.

18. The touch area adjustment method as claimed in claim 17 further comprises the following step:
redefining the boundary of the inactive area to increase the operating range of the touch area, thus enabling the touch area to correspond with the boundary of the image.

19. The touch area adjustment method as claimed in claim 17 further comprises the following steps:
redefining the boundary of the inactive area to increase a new operating area; and
displaying a new operating image which allows the boundary of the new operating area and the new operating image to correspond with each other.

20. The touch area adjustment method as claimed in claim 12, wherein the step of determining whether the touch display device simultaneously displays the image and an inactive area further comprises the following step:
using a comparison table to correspond with the signal resolution and the display status; or
performing direct calculation with the signal resolution and the display status.
